(19) United States
(12) Patent Application Publication
(10) Pub. No.: US 2008/0070041 A1
(43) Pub. Date: Mar. 20, 2008

(54) Fuser member having blended fluoroelastomer outer layer

(75) Inventors: Alan R. Kuntz, Webster, NY (US); Joy L. Longhenry, Webster, NY (US); Richard P. Carney, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/524,155

(22) Filed: Sep. 19, 2006

(51) Int. Cl. G03G 15/20; B32B 27/20; B32B 27/40; B32B 27/30; B32B 25/20

(52) U.S. Cl. 428/421; 399/333; 428/447; 428/423.1; 428/522

(57) ABSTRACT

A fuser member having a substrate, and thereover, an outer layer including a fluoroelastomer blend, wherein the fluoroelastomer blend has a) a filled-fluoroelastomer composition with a first fluoroelastomer and a polymer filler, and b) an unfilled-fluoroelastomer with a second fluoroelastomer without any filler.

### BACKGROUND

The disclosure herein relates generally to an imaging apparatus and fuser components thereof for use in electrostatographic, including digital, image-on-image, and like apparatuses. The fuser members are useful for many purposes including fixing a toner image to a copy substrate. More specifically, the disclosure relates to fuser components comprising an outer layer comprising a blend of filled-fluoroelastomer and unfilled-fluoroelastomer compositions. In embodiments, the blended fluoroelastomer outer layer is positioned on a substrate, which may be of many configurations including a roller, belt, film, or like substrate. In other embodiments, the fluoroelastomer outer layer has an outer release layer thereon. In embodiments, there is positioned between the substrate and the outer fluoroelastomer layer, an intermediate and/or adhesive layer. In embodiments, the fluoroelastomer filled composition includes a polymer filler, such as a TEFLON®-like polymer filler. The fuser members may be useful in xerographic machines, such as copiers, printers, facsimiles, multifunction machines, and including color machines.

In a typical electrostatographic reproducing apparatus, a light image of an original to be copied is recorded in the form of an electrostatic latent image upon a photosensitive member and the latent image is subsequently rendered visible by the application of electroscopic thermoplastic resin particles which are commonly referred to as toner. The visible toner image is then in a loose powdered form and can be easily disturbed or destroyed. The toner image is usually fixed or fused upon a support, which may be the photosensitive member itself, or other support sheet such as plain paper.

The use of thermal energy for fixing toner images onto a support member is well known and methods include providing the application of heat and pressure substantially concurrently by various means, a roll pair maintained in pressure contact, a belt member in pressure contact with a roll, a belt member in pressure contact with a heater, and the like. Heat may be applied by heating one or both of the rolls, plate members, or belt members. With a fixing apparatus using a thin film in pressure contact with a heater, the electric power consumption is small, and the warming-up period is significantly reduced or eliminated.

It is desired in the fusing process that minimal or no offset of the toner particles from the support to the fuser member take place during normal operations. Toner particles offset onto the fuser member may subsequently transfer to other parts of the machine or onto the support in subsequent copying cycles, thus increasing the background or interfering with the material being copied there. The referred to “hot offset” occurs when the temperature of the toner is increased to a point where the toner particles liquefy and a splitting of the molten toner takes place during the fusing operation with a portion remaining on the fuser member. The hot offset temperature or degradation of the hot offset temperature is a measure of the release property of the fuser, and accordingly it is desired to provide a fusing surface, which has a low surface energy to provide the necessary release. To ensure and maintain good release properties of the fuser, it has become customary to apply release agents to the fuser roll during the fusing operation. Typically, these materials are applied as thin films of, for example, silicone oils to prevent toner offset.

Another method for reducing offset, is to impart antistatic and/or field assisted toner transfer properties to the fuser. However, to control the electrical conductivity of the release layer, the conformability and low surface energy properties of the release layer are often affected.

U.S. Pat. No. 5,401,570 discloses a silicone layer with inorganic fillers such as metal oxides therein.

U.S. Pat. No. 6,923,533 discloses a phase change ink imaging member using phase change ink as the developer material, wherein the outer layer comprises a fluoroelastomer having a nano-size filler dispersed or contained therein. Included as examples of nano-size fillers are polytetrafluoroethylene fillers.

Known fuser coatings include high temperature polymers such as polytetrafluoroethylene, perfluoroalkoxy, fluorinated ethylene propylene, silicone rubber, fluorosilicone rubber, fluoroelastomers, and the like. These coatings have been found to have adequate release properties and control toner offset sufficiently. However, these coatings do not tend to stay clean during use. Further, the coatings do not maintain a uniform surface. More specifically, the coatings often wear during use and/or become scratched during operation. In addition, these known surfaces often react with the toner and/or oil and/or debris from media, which causes the surface to become dirty and/or contaminated. The surface can, in turn, become physically damaged. The result of these problems is that the fuser member has a reduced useful function and short life. Another problem resulting from release coatings with high friction is unacceptable copy or print quality defects. The high friction often associated with conformable coatings may result in the generation of waves in the media being fused and/or the fuser member itself. This, in turn, results in copies or prints with localized areas of poorer fix and/or differential gloss.

Some of the above problems have been solved by recent improvements of adding polymer fillers to outer layers. Other failure modes include an offset failure mode problem. Other failure modes are staining and paper edge wear. Further, wave defects have resulted.

Therefore, a need remains for fuser coatings having reduced susceptibility to contamination, scratching, and other damage. In addition, a need remains for fuser components having longer life. In addition, a need remains for fuser components with low friction while being resistant to scratching and other damage.

### SUMMARY

Embodiments include, a fuser member comprising a substrate, and thereover, an outer layer comprising a fluoroelastomer blend, wherein the fluoroelastomer blend comprises a) a filled-fluoroelastomer composition comprising a first fluoroelastomer and a polymer filler, and b) an unfilled-fluoroelastomer composition comprising a second fluoroelastomer without any filler.

Embodiments further include a fuser member comprising a substrate, and thereover, an outer layer comprising a fluoroelastomer blend, wherein the fluoroelastomer blend comprises a) a filled-fluoroelastomer composition comprising a first fluoroelastomer and a polytetrafluoroethylene filler, and b) an unfilled-fluoroelastomer composition comprising a second fluoroelastomer without any filler.

In addition, embodiments include an image forming apparatus for forming images on a recording medium comprising a charge-retentive surface to receive an electrostatic latent image thereon; a development component to apply toner to the charge-retentive surface to develop an electrostatic latent image to form a developed image on the charge retentive surface; a transfer film component to transfer the developed image from the charge retentive surface to a copy substrate; and a fuser member and fuser member for fusing toner images to a surface of the copy substrate, wherein the fuser member comprises a substrate, and thereover, an outer layer comprising a fluoroelastomer blend, wherein the fluoroelastomer blend comprises a) a filled-fluoroelastomer composition comprising a first fluoroelastomer and a filler, and b) an unfilled-fluoroelastomer composition comprising a second fluoroelastomer without any filler.

### BRIEF DESCRIPTION OF THE DRAWINGS

The above embodiments will become apparent as the following description proceeds upon reference to the drawings, which include the following figures:

FIG. 1 is an illustration of a general electrostatographic apparatus.

FIG. 2 is a sectional view of a fusing assembly in accordance with one embodiment disclosed herein.

FIG. 3 is a sectional view of a fuser roller having a three-layer configuration.

### DETAILED DESCRIPTION

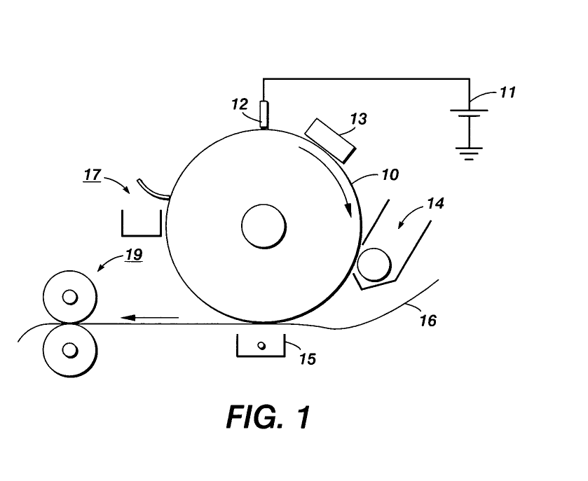

Referring to FIG. 1, in a typical electrostatographic reproducing apparatus, a light image of an original to be copied is recorded in the form of an electrostatic latent image upon a photosensitive member and the latent image is subsequently rendered visible by the application of electroscopic thermoplastic resin particles which are commonly referred to as toner. Specifically, photoreceptor 10 is charged on its surface by means of a charger 12 to which a voltage has been supplied from power supply 11. The photoreceptor is then imagewise exposed to light from an optical system or an image input apparatus 13, such as a laser and light emitting diode, to form an electrostatic latent image thereon. Generally, the electrostatic latent image is developed by bringing a developer mixture from developer station 14 into contact therewith. Development can be effected by use of a magnetic brush, powder cloud, or other known development process. A dry developer mixture usually comprises carrier granules having toner particles adhering triboelectrically thereto. Toner particles are attracted from the carrier granules to the latent image forming a toner powder image thereon. Alternatively, a liquid developer material may be employed, which includes a liquid carrier having toner particles dispersed therein. The liquid developer material is advanced into contact with the electrostatic latent image and the toner particles are deposited thereon in image configuration.

After the toner particles have been deposited on the photoconductive surface, in image configuration, they are transferred to a copy sheet 16 by transfer means 15, which can be pressure transfer or electrostatic transfer. Alternatively, the developed image can be transferred to an intermediate transfer member and subsequently transferred to a copy sheet.

After the transfer of the developed image is completed, copy sheet 16 advances to fusing station 19, depicted in FIG. 1 as fusing and pressure rolls, wherein the developed image is fused to copy sheet 16 by passing copy sheet 16 between the fusing member 5 and pressure member 6, thereby forming a permanent image. Photoreceptor 10, subsequent to transfer, advances to cleaning station 17, wherein any toner left on photoreceptor 10 is cleaned therefrom by use of a blade (as shown in FIG. 1), brush, or other cleaning apparatus.

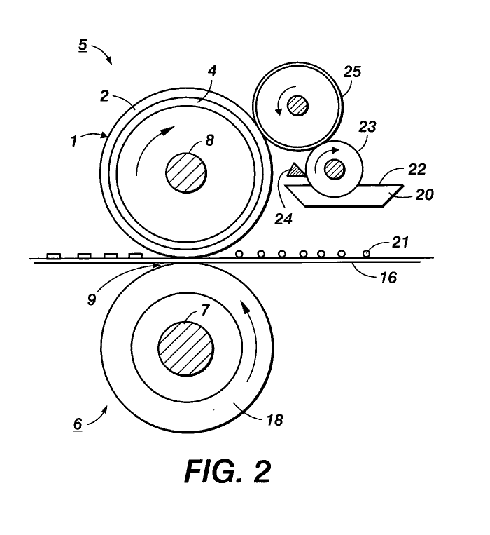

In FIG. 2, fuser roller 5 can be a hollow cylinder or core fabricated from any suitable metal, such as aluminum, anodized aluminum, steel, nickel, copper, and the like, having a suitable heating element 8 disposed in the hollow portion thereof which is coextensive with the cylinder.

Backup or pressure roll 6 cooperates with fuser roll 5 to form a nip or contact arc 9 through which a copy paper or other substrate 16 passes such that toner images 21 thereon contact fluoroelastomer surface 2 of fuser roll 5. As shown in FIG. 2, the backup roll 6 has a rigid steel core 7 with a fluoroelastomer surface or layer 18 thereon. Sump 20 contains polymeric release agent 22 which may be a solid or liquid at room temperature, but it is a fluid at operating temperatures.

In the embodiment shown in FIG. 2 for applying the polymeric release agent 22 to fluoroelastomer surface 2, two release agent delivery rolls 23 and 25 rotatably mounted in the direction indicated are provided to transport release agent 22 to fluoroelastomer surface 2. Delivery roll 23 is partly immersed in the sump 20 and transports on its surface release agent from the sump to the delivery roll 23. By using a metering blade 24, a layer of polymeric release fluid can be applied initially to delivery roll 23 and subsequently to fluoroelastomer 2 in controlled thickness ranging from submicrometer thickness to a thickness of several micrometers of release fluid. Thus, by metering device 24, about 0.1 to about 2 micrometers or greater thicknesses of release fluid can be applied to the surface of fluoroelastomer 2.

The fusing component can be comprised of at least three different configurations. In one embodiment, the fusing component is of a two-layer configuration as shown in FIG. 2. Fuser member 5 having heating element 8, comprises substrate 4. Positioned over the substrate 4 is outer fluoroelastomer layer 2.

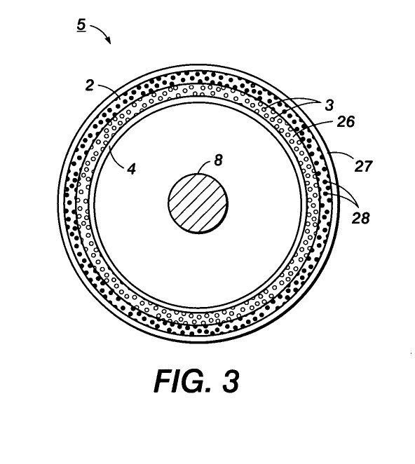

FIG. 3 demonstrates a three-layer configuration, wherein fuser roller 5 has heating member 8 inside, and thereover substrate 4 and having intermediate layer 26 (which can be a silicone rubber) positioned on substrate 4, and outer layer 2 positioned on intermediate layer 26. FIG. 3 demonstrates optional fillers 3 and 28, which may be the same or different, and can be dispersed optionally in the intermediate layer 26, and/or optionally in the outer layer 2.

In embodiments, there may be present an outer release layer 27 positioned on the outer layer 2 as shown in FIG. 3.

Examples of suitable substrate materials include, in the case of roller substrate, metals such as aluminum, stainless steel, steel, nickel and the like. In the case of film-type substrates (in the event the substrate is a fuser belt, film, drelt (a cross between a drum and a belt) or the like) suitable substrates include high temperature plastics that are suitable for allowing a high operating temperature (i.e., greater than about 80° C., or greater than 200° C.), and capable of exhibiting high mechanical strength.

The outer layer comprises a blended fluoroelastomer alloy. The blend comprises a filled-fluoroelastomer and an unfilled-fluoroelastomer. The first filled-fluoroelastomer and the second unfilled-fluoroelastomer may be the same or different.

Examples of suitable fluoroelastomers include copolymers and terpolymers of vinylidenefluoride, hexafluoropropylene and tetrafluoroethylene, which are known commercially under various designations as VITON A®, VITON E®, VITON E60C®, VITON E45®, VITON E430®, VITON 910®, VITON GH®, VITON B50®, and VITON GF®. The VITON® designation is a Trademark of E.I. DuPont de Nemours, Inc. Other commercially available materials include FLUOREL 2170®, FLUOREL 2174®, FLUOREL 2176®, FLUOREL 2177® and FLUOREL LVS 76® FLUOREL® being a Trademark of 3M Company. Additional commercially available materials include AFLAS™ a poly(propylene-tetrafluoroethylene) and FLUOREL II® (LII900) a poly(propylene-tetrafluoroethylene vinylidenefluoride) both also available from 3M Company, as well as the Tecnoflons identified as FOR-60KIR®, FOR-LHF®, NM® FOR-THF®, FOR-TFS®, TH®, TN505® available from Montedison Specialty Chemical Company.

Two specific known fluoroelastomers are (1) a class of copolymers of one or more of, or any combination of vinylidenefluoride, tetrafluoroethylene and hexafluoropropylene known commercially as VITON A® and (2) a class of terpolymers of vinylidenefluoride, hexafluoropropylene, and tetrafluoroethylene known commercially as VITON B®. VITON A®, and VITON B®, and other VITON® designations are trademarks of E.I. DuPont de Nemours and Company.

In another embodiment, the fluoroelastomer is a tetrapolymer having a relatively low quantity of vinylidenefluoride. An example is VITON GF®, available from E.I. DuPont de Nemours, Inc. The VITON GF® has 35 weight percent of vinylidenefluoride, 34 weight percent of hexafluoropropylene and 29 weight percent of tetrafluoroethylene with 2 weight percent cure site monomer. The cure site monomer can be those available from DuPont such as 4-bromoperfluorobutene-1, 1,1-dihydro-4-bromoperfluorobutene-1,3-bromoperfluoropropene-1,1,1-dihydro-3-bromoperfluoropropene-1, or any other suitable, known, commercially available cure site monomer.

In embodiments, the filled fluoroelastomer can include those commercially available under the trade name P95930M from Solvay Solexis, which is a 30% by weight PTFE-filled fluoroelastomer. The fluoroelastomer is a tetrapolymer of vinylidene fluoride, hexafluoropropylene, tetrafluoroethylene and a cure site monomer. The PTFE particles are approximately 40 nm in size and are dispersed in the fluoroelastomer matrix during the manufacture of the fluoroelastomer.

In embodiments, a filled tetrapolymer of vinylidene fluoride, hexafluoropropylene, tetrafluoroethylene and a cure site monomer, is blended with an unfilled tetrapolymer of vinylidene fluoride, hexafluoropropylene, tetrafluoroethylene, and a cure site monomer.

In embodiments, the filler in the filled-fluoroelastomer composition is a fluoropolymer such as polytetrafluoroethylene (PTFE), fluorinated ethylenepropylene copolymer (FEP), polyfluoroalkoxy polytetrafluoroethylene (PFA TEFLON®), ethylene chlorotrifluoro ethylene (ECTFE), ethylene tetrafluoroethylene (ETFE), polytetrafluoroethylene perfluoromethylvinylether copolymer (MFA), and the like, and mixtures thereof. The polymer filler has a particle size of from about 1 to about 40 nm.

The filler is present in the filled-fluoroelastomer composition in an amount of from about 10 to about 50 percent, or from about 20 to about 40 percent, or from about 30 to about 35 percent by weight of total solids.

In embodiments, the weight ratio of the filled-fluoroelastomer composition to the unfilled-fluoroelastomer composition in the outer layer is from about 0.01/99.9 to about 25/75, or from about 1/99 to about 10/90, or from about 2/98 to about 5/95.

The outer fluoroelastomer blend can be coated on the substrate using any suitable known manner. Typical techniques for coating such materials on the reinforcing member include liquid and dry powder spray coating, dip coating, wire wound rod coating, fluidized bed coating, powder coating, electrostatic spraying, sonic spraying, blade coating, and the like. In an embodiment, the fluoroelastomer blend is spray or flow coated to the substrate. Details of the flow coating procedure can be found in U.S. Pat. No. 5,945,223, the disclosure of which is hereby incorporated by reference in its entirety.

The fluoroelastomer blend is of a thickness of from about 5 to about 100 microns, or from about 20 to about 40 microns, or from about 15 to about 25 microns.

In an embodiment, the outer fluoroelastomer blended layer may be modified by any known technique such as sanding, polishing, grinding, blasting, coating, or the like. In embodiments, the outer fluoroelastomer blended layer has a surface roughness of from about 0.02 to about 1.5 micrometers, or from about 0.3 to about 0.8 micrometers. In the three layer embodiment, wherein an optional release layer is provided on the fluoroelastomer outer layer, the outer release layer surface can also be roughened in the same or similar manner as just described.

In an embodiment, the blended fluoroelastomer outer layer has a gardiner gloss of approximately from about 40 to about 100 ggu, or from about 60 to about 80 ggu, or about 70 to about 78 ggu.

The adhesion of the fluoroelastomer blended outer layer can be from about 1.5 to about 3 lb/in, or from about 2.1 to about 2.8 lb/in, or from about 2.2 to about 2.8 lb/in.

The outer layer comprising the fluoroelastomer blend can have a tensile strength of from about 1100 psi to 1900 psi, or from about 1200 to about 1500 psi.

In embodiments, an intermediate layer can be positioned between the substrate and fluoroelastomer blended outer layer. In other embodiments, an outer release layer can be positioned on the fluoroelastomer blended outer layer.

Examples of suitable intermediate layers or suitable optional outer release layers include silicone rubber, fluoropolymer, urethane, acrylic, titamer, ceramer, hydrofluoroelastomer, polymers, (such as polymers, copolymers, terpolymers and the like) or mixtures thereof, and fillers such as carbon black and/or aluminum oxide. In embodiments, the intermediate layer comprises a silicone rubber.

The optional intermediate layer and/or optional outer release layer can be coated to the fluoroelastomer outer layer using any known, suitable technique. In an embodiment, the additional layers can be spray or flow coated.

The intermediate layer can have a thickness of from about 2 to about 10 mm, or from about 3 to about 9 mm, or from about 5 to about 8 mm.

The outer release layer can be coated on the outer fluoroelastomer layer to a thickness of from about 1 to about 50 um, or from about 5 to about 30 um. The outer release layer can be any of the polymer coatings described above for use as the intermediate layer.

The fusing component can be of any suitable configuration. Examples of suitable configurations include a sheet, a film, a web, a foil, a strip, a coil, a cylinder, a drum, a roller, an endless strip, a circular disc, a belt including an endless belt, an endless seamed flexible belt, an endless seamless flexible belt, an endless belt having a puzzle cut seam, and the like. In an embodiment, the fuser member is a fuser roller. In embodiments, the substrate of the fuser roller is metal, such as aluminum or steel.

Optionally, any known and available suitable adhesive layer may be positioned between the fluoroelastomer outer layer and the substrate, and/or between the outer fluoroelastomer layer and the outer release layer. Examples of suitable adhesives include silanes such as amino silanes (such as, for example, HV Primer 10 from Dow Corning), titanates, zirconates, aluminates, and the like, and mixtures thereof. In an embodiment, an adhesive in from about 0.001 to about 10 percent solution can be wiped on the substrate. The adhesive layer can be coated on the substrate, or on the fluoroelastomer outer layer, to a thickness of from about 2 to about 2,000 nanometers, or from about 2 to about 500 nanometers. The adhesive can be coated by any suitable, known technique, including spray coating or wiping.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

The following Examples are intended to illustrate and not limit the scope herein. Parts and percentages are by weight unless otherwise indicated.

### EXAMPLES

### Example 1

Formation of Fuser Member Coating

A fuser member coating formulation was prepared from a solvent solution/dispersion containing 100 parts by weight of a hydrofluoroelastomer, DuPont VITON® GF (a tetrapolymer of 35 weight percent vinylidenefluoride, 34 weight percent hexafluoropropylene, 29 weight percent tetrafluoroethylene, and 2 weight percent of a cure site monomer). The VITON® GF was mixed with 7 parts by weight of DuPont VITON® Curative 50, 1.5 parts by weight magnesium oxide (ElastoMag 170 Special available from Rohm and Hass, Andover Mass.), 0.75 parts by weight calcium hydroxide, 0.75 parts by weight carbon black (N990 available from R. T. Vanderbilt Co.), 4.89 parts by weight Novec® FC-4430 (available from 3M) and 0.86 parts by weight AKF-290 (available by Wacker) in a mixture of methylethylketone and methylisobutyl ketone. This coating formulation was dispensed onto a fuser roll surface via flow coating to a nominal thickness of about 20 micrometers. The coating was cured by stepwise heating in air at 95° C. for 2 hours, 175° C. for 2 hours, 205° C. for 2 hours, and 230° C. for 24 hours.

### Example II

Formation of Fuser Member Coating Comprising Teflon-Filled Fluoroelastomer Blended with Unfilled-Fluoroelastomer

Fuser roll topcoat formulations were prepared identically to Example I and II except that P95930M (available from Solvay Solexis) was added. The amount of the P95930M to VITON® GF used was varied from about 3 to 30 percent by weight.

The optimum formulation, based on mechanical properties from the experiment described in Example II is about 30 percent by weight of P95930M, 5.84 pph VC-50, 2.5 pph Novec FC4432 (available from 3M), about 3.5 pph magnesium oxide, about 1.75 pph calcium hydroxide, and 0.75 pph of carbon black. The coating was cured by stepwise heating in air at 95° C. for 2 hours, 175° C. for 2 hours, 205° C. for 2 hours, and 230° C. for 24 hours.

### Example III

Comparative Testing

The fuser member coatings prepared above were measured for adhesion, gloss and mechanical properties, including tensile strength, toughness, and elongation. The Example II coating has improved mechanical properties, as listed in the Table below.

TABLE I
Comparison of Coating Properties

| | | | Tensile | | |
|---|---|---|---|---|---|
| | Gloss | Adhesion | Strength | Toughness | |
| Coating | (ggu) | (lb/in) | (psi) | (in-lb/in³) | Elongation |
| Example I | 74 | 2.0 | 1305 | 1278 | 220 |
| Example II | 64.4 | 2.1 | 1724 | 1558 | 209 |

It is clear from the above that Example II formulations (blend of filled-fluoroelastomer and unfilled-fluoroelastomer performed superior to that of Example 1 which just comprises a fluoroelastomer.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A fuser member comprising a substrate, and thereover, an outer layer comprising a fluoroelastomer blend, wherein said fluoroelastomer blend comprises a) a filled-fluoroelastomer composition comprising a first fluoroelastomer and a polymer filler, and b) an unfilled-fluoroelastomer comprising a second fluoroelastomer without any filler.

2. The fuser member of claim 1, wherein said first fluoroelastomer is selected from the group consisting of a) copolymers of two of vinylidene fluoride, hexafluoropropylene, and tetrafluoroethylene, b) terpolymers of vinylidene fluoride, hexafluoropropylene, and tetrafluoroethylene, and c) tetrapolymers of vinylidene fluoride, hexafluoropropylene, tetrafluoroethylene, and a cure site monomer.

3. The fuser member of claim 2, wherein said first fluoroelastomer is a tetrapolymer of vinylidene fluoride, hexafluoropropylene, tetrafluoroethylene and a cure site monomer.

4. The fuser member of claim 1, wherein said second fluoroelastomer is selected from the group consisting of a) copolymers of two of vinylidene fluoride, hexafluoropropylene, and tetrafluoroethylene, b) terpolymers of vinylidene fluoride, hexafluoropropylene, and tetrafluoroethylene, and c) tetrapolymers of vinylidene fluoride, hexafluoropropylene, tetrafluoroethylene, and a cure site monomer.

5. The fuser member of claim 4, wherein said second fluoroelastomer is a tetrapolymer of vinylidene fluoride, hexafluoropropylene, tetrafluoroethylene and a cure site monomer.

6. The fuser member of claim 1, wherein said polymer filler is selected from the group consisting of polytetrafluoroethylene, fluorinated ethylenepropylene copolymer, polyfluoroalkoxy polytetrafluoroethylene, ethylene chlorotrifluoro ethylene, ethylene tetrafluoroethylene, polytetrafluoroethylene perfluoromethylvinylether copolymer, and mixtures thereof.

7. The fuser member of claim 6, wherein said polymer filler is polytetrafluoroethylene.

8. The fuser member of claim 1, wherein said polymer filler is present in said filled-fluoroelastomer composition in an amount of from about 10 to about 50 percent by weight of total solids.

9. The fuser member of claim 8, wherein said polymer filler is present in said filled-fluoroelastomer composition in an amount of from about 20 to about 40 percent by weight of total solids.

10. The fuser member of claim 9, wherein said polymer filler is present in said filled-fluoroelastomer composition in an amount of from about 30 to about 35 percent by weight of total solids.

11. The fuser member of claim 1, wherein said weight ratio of said filled-fluoroelastomer composition to unfilled-fluoroelastomer composition is from about 0.01/99.9 to about 25/75.

12. The fuser member of claim 11, wherein said weight ratio of said filled-fluoroelastomer composition to unfilled-fluoroelastomer composition is from about 1/99 to about 10/90.

13. The fuser member of claim 12, wherein said weight ratio of said filled-fluoroelastomer composition to unfilled-fluoroelastomer composition is from about 2/98 to about 5/95.

14. The fuser member of claim 1, wherein said outer layer has a gloss of from about 40 to about 100 ggu.

15. The fuser member of claim 14, wherein said outer layer has a gloss of from about or from about 60 to about 80 ggu.

16. The fuser member of claim 1, wherein said outer layer has an adhesion of from about 1.50 to about 3 lb/in.

17. The fuser member of claim 1, wherein an intermediate layer is positioned between said substrate and said outer layer.

18. The fuser member of claim 17, wherein said intermediate layer comprises a material selected from the group consisting of silicone rubber, fluoropolymer, urethane, acrylic, titamer, ceramer, hydrofluoroelastomer such as volume grafted fluoroelastomers, polymers thereof, and mixtures thereof.

19. The fuser member of claim 18, wherein said intermediate layer comprises silicone rubber.

20. A fuser member comprising a substrate, and thereover, an outer layer comprising a fluoroelastomer blend, wherein said fluoroelastomer blend comprises a) a filled-fluoroelastomer composition comprising a first fluoroelastomer and a polytetrafluoroethylene filler, and b) an unfilled-fluoroelastomer composition comprising a second fluoroelastomer without any filler.

21. An image forming apparatus for forming images on a recording medium comprising a charge-retentive surface to receive an electrostatic latent image thereon; a development component to apply toner to the charge-retentive surface to develop an electrostatic latent image to form a developed image on the charge retentive surface; a transfer component to transfer the developed image from the charge retentive surface to a copy substrate; and a fuser member for fusing toner images to a surface of the copy substrate, wherein said fuser member comprises a substrate, and thereover, an outer layer comprising a fluoroelastomer blend, wherein said fluoroelastomer blend comprises a) a filled-fluoroelastomer composition comprising a first fluoroelastomer and a polymer filler, and b) an unfilled-fluoroelastomer comprising a second fluoroelastomer without any filler.
